(19) United States
(12) Patent Application Publication
(10) Pub. No.: US 2015/0241214 A1
(43) Pub. Date: Aug. 27, 2015

(54) Wood level

(71) Applicant: Charles V. Barnhart, Brooklyn, NY (US)

(72) Inventor: Charles V. Barnhart, Brooklyn, NY (US)

(21) Appl. No.: 13/999,186

(22) Filed: Feb. 26, 2014

(51) Int. Cl. G01C 9/02

(52) U.S. Cl. CPC G01C 9/02

(57) ABSTRACT

Wood Level is designed to assist in the leveling or plumbing of wood. This device is ideal for use by craftsman who works with wood in framing, carpentry and construction. The level can be easily affixed to the wood, eliminating the hassle of trying to steady both the wood and the level separately. This product improves the leveling process by making it easier and faster, thereby increasing productivity.

Wood Level can be attached to any wood member that is to be leveled. The level includes a fastening arrangement at both ends. This arrangement enables the level to be attached to the wood. The assembly may consist of two buttons on each end, pins that can be inserted into the wood member, and springs on each end that work in conjunction with the buttons and pins. When the buttons are pressed, the pin is released and enters the wood just enough for the level to be temporarily fastened to the wood member. The pins can be easily retracted after the leveling or plumbing is complete. The tool can be used to level horizontal and vertical members. The level may be approximately 2′ long and about the same width as traditional level. It may be composed of aluminum or suitable material. The exact specifications may vary.

### DETAILED DESCRIPTION OF DRAWINGS ATTACHED

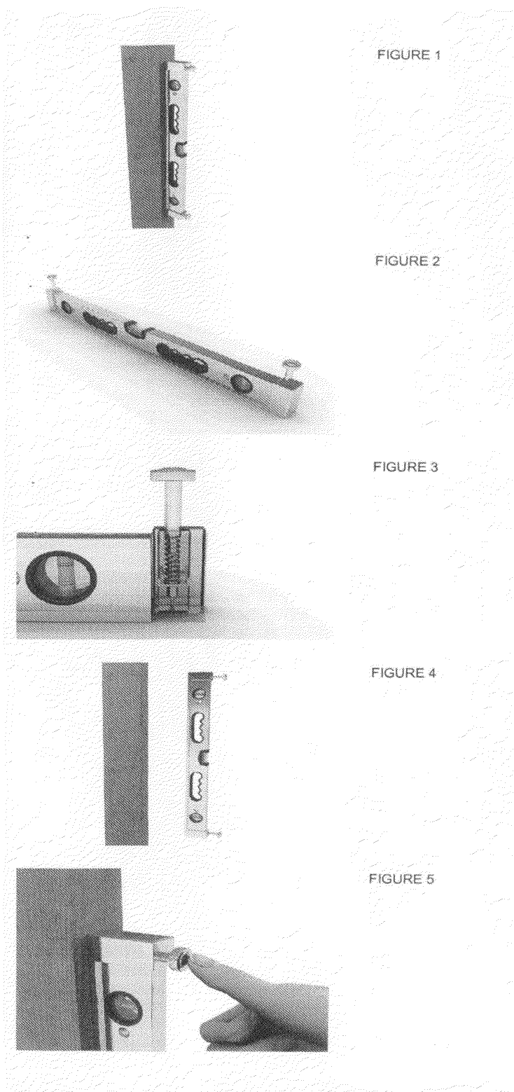

FIG. 1: the level attached to a piece of wood.

FIG. 2: the tool by itself.

FIG. 3: the pin and spring assembly.

FIG. 4: how the tool can be used to level horizontal and vertical members.

FIG. 5: the button being pressed.

Note: These specifications contain no new matter

1. Invention Wood Level
I, Charles Barnhart claim the Invention Wood Level
